(19) United States
(12) Patent Application Publication
(10) Pub. No.: US 2024/0097866 A1
(43) Pub. Date: Mar. 21, 2024

(54) Methods And Apparatus For SBFD-Aware UE Configuration In Mobile Communications

(71) Applicant: MediaTek Singapore Pte. Ltd., Singapore (SG)

(72) Inventors: Jozsef Gabor Nemeth, Cambridge (GB); Mohammed S Aleabe Al-Imari, Cambridge (GB)

(21) Appl. No.: 18/242,626

(22) Filed: Sep. 6, 2023

Related U.S. Application Data
(60) Provisional application No. 63/375,705, filed on Sep. 15, 2022.
(60) Provisional application No. 63/378,088, filed on Oct. 3, 2022.

(51) Int. Cl. H04L 5/00; H04L 5/14; H04W 72/0446

(52) U.S. Cl. CPC H04L 5/0094; H04L 5/0039; H04L 5/14; H04W 72/0446

(57) ABSTRACT

Techniques pertaining to configuration of subband-fullduplex (SBFD)-aware user equipment (UE) in mobile communications are described. A UE receives a signaling from a network configuring one or more frequency-domain subband partitions per serving cell. The UE communicates with the network using resources in the one or more frequency-domain subband partitions. Each of the one or more frequency-domain subband partitions respectively comprises a set of uplink (UL) subbands and a set of downlink (DL) subbands. Each subband of the set of UL subbands and the set of DL subbands respectively comprises a set of one or more contiguous resource blocks (RBs).

### CROSS REFERENCE TO RELATED PATENT APPLICATION(S)

The present disclosure is part of a non-provisional application claiming the priority benefit of U.S. Patent Application Nos. 63/375,705 and 63/378,088, filed 15 Sep. 2022 and 3 Oct. 2022, respectively, the contents of which herein being incorporated by reference in their entirety.

### TECHNICAL FIELD

The present disclosure is generally related to mobile communications and, more particularly, to techniques for configuration of subband-fullduplex (SBFD)-aware user equipment (UE) in mobile communications.

### BACKGROUND

Unless otherwise indicated herein, approaches described in this section are not prior art to the claims listed below and are not admitted as prior art by inclusion in this section.

In wireless communications, such as mobile communications under the 3^{rd} Generation Partnership Project (3GPP) specification(s) for 5^{th} Generation (5G) New Radio (NR), in non-overlapping SBFD radio access network (RAN) deployments with half-duplexed UEs, there is a need for SBFD layout configuration of UEs. For example, enhanced resource allocations need to adjust to changing network resources as SBFD and non-SBFD slots/symbols alternate based on knowledge of the SBFD layout on the UE's part. Notably, resource fragmentation in frequency or in time is to be avoided. Moreover, enhanced resource allocations which are also compatible with inter-UE multiplexing of physical-layer (PHY) channel resources in coexistence with legacy UEs, may not be aware of SBFD partitioning and may need to rely on a single uplink-downlink (UL-DL) bandwidth part (BWP) pair for SBFD operation. A base station (BS) should be able to signal a UE to allow or prohibit repetitions crossing boundaries between SBFD and non-SBFD slots/symbols as these alternate. Notably, uplink coverage extension is one of the main motivations for SBFD operation.

There is also a need for support of transition between non-partitioned and partitioned resources (and vice versa) in the configured SBFD layout on any symbol boundary for flexible UL/DL network resource ratio. Additionally, there is a need to protect against inter-UE collision at DL-UL turn-around. Moreover, there is a need for support of turning points at different symbols per different subbands. Furthermore, there is a need for support of dynamic decisions by a BS on SBFD network layout. This may need to be reconciled with minimized standardization effort and minimized dynamic layer 1/layer 2 (L1/L2) signaling overhead. Also, there is a need for support of intra-cell, inter-subband UE-UE cross-link interference (CLI) mitigation (e.g., by sounding reference signal reference signal received power (SRS-RSRP) measurements in UL subband. Besides, there are fundamental design alternatives, assuming that UE is configured semi-statically with SBFD layout in frequency and time.

Therefore, there is a need for a solution of configuration of SBFD-aware UEs in mobile communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure are believed to provide solutions involving configuration of SBFD-aware UEs in mobile communications. It is believed that implementations of various proposed schemes in accordance with the present disclosure may address or otherwise alleviate the issue(s) described herein.

In one aspect, a method may involve a UE receiving a signaling from a network configuring one or more frequency-domain subband partitions per serving cell. The method may also involve the UE communicating with the network using resources in the one or more frequency-domain subband partitions. Each of the one or more frequency-domain subband partitions may respectively include a set of uplink (UL) subbands and a set of downlink (DL) subbands. Each subband of the set of UL subbands and the set of DL subbands may respectively include a set of one or more contiguous resource blocks (RBs).

In another aspect, a method may involve a UE receiving a signaling from a network. The method may also involve the UE performing a measurement outside a DL subband while the UE is not allowed to receive any signaling in the DL subband.

It is noteworthy that, although description provided herein may be in the context of certain radio access technologies, networks and network topologies such as 5G/NR mobile communications, the proposed concepts, schemes and any variation(s)/derivative(s) thereof may be implemented in, for and by other types of radio access technologies, networks and network topologies such as, for example and without limitation, Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various proposed schemes in accordance with the present disclosure may be implemented.

FIG. 2 is a diagram of an example scenario in accordance with an implementation of the present disclosure.

FIG. 3 is a diagram of an example scenario in accordance with an implementation of the present disclosure.

FIG. 4 is a diagram of an example scenario in accordance with an implementation of the present disclosure.

FIG. 5 is a diagram of an example scenario in accordance with an implementation of the present disclosure.

FIG. 6 is a diagram of an example scenario in accordance with an implementation of the present disclosure.

FIG. 7 is a diagram of an example scenario in accordance with an implementation of the present disclosure.

FIG. 8 is a diagram of an example scenario in accordance with an implementation of the present disclosure.

FIG. 9 is a diagram of an example scenario in accordance with an implementation of the present disclosure.

FIG. 10 is a diagram of an example scenario in accordance with an implementation of the present disclosure.

FIG. 11 is a diagram of an example scenario in accordance with an implementation of the present disclosure.

FIG. 12 is a block diagram of an example communication system in accordance with an implementation of the present disclosure.

FIG. 13 is a flowchart of an example process in accordance with an implementation of the present disclosure.

FIG. 14 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to configuration of SBFD-aware UEs in mobile communications. According to the present disclosure, a number of possible solutions may be implemented separately or jointly. That is, although these possible solutions may be described below separately, two or more of these possible solutions may be implemented in one combination or another.

In the present disclosure, the term “subband” or “cluster” may refer to a contiguous set of resource blocks (RBs) sharing the same link direction. The term “group of RBs” or “RB set” may refer to a set of contiguous RBs within a carrier and should be distinguished from the existing concept of “RB sets” in Release 17 (R17) of the 3GPP specification regarding New Radio unlicensed band (NR-U), which are used in wideband operation over shared spectrum. The concept of cluster availability is based on listen-before-talk in R17 while, in R18, cluster availability for sending or receiving is based on a periodic subband layout pattern. In R17, all UEs use the same cluster availability, whereas in R18, cluster configurations may be different per UE. Moreover, non-contiguous cluster operation is not allowed in R17, whereas in R18, non-contiguous cluster operation needs to be supported. Furthermore, in R18, it is assumed that there is co-existence of legacy UEs (time-division duplex (TDD)) and enhanced UEs (SBFD-aware). The term “CLI” may refer to cross-link interference (e.g., UE/UL-to-UE/DL, gNB/DL-to-gNB/UL). The term “SIC” may refer to self-interference cancellation on the gNB side. The term “CC” may refer to component carrier in the context of carrier aggregation (CA) or multi-carrier duplexing. The term “RateMatchPattern” may refer to a concept used by the 3GPP standard to define a frequency-time region and its repetitions (called a pattern) over the network resources that are excluded from those network resources used by a DL transmission scheduled in an overlapping region. To send the same payload over less resources, the coding rate needs to be matched. The term “active UE DL cluster” may refer to a cluster that is schedulable for a UE in a given slot when the UE is receiving. The term “active UE UL cluster” may refer to a cluster that is schedulable for a UE in a given slot when the UE is transmitting. The term “active UE cluster” may refer to any DL or UL cluster that is schedulable for the UE in a given slot.

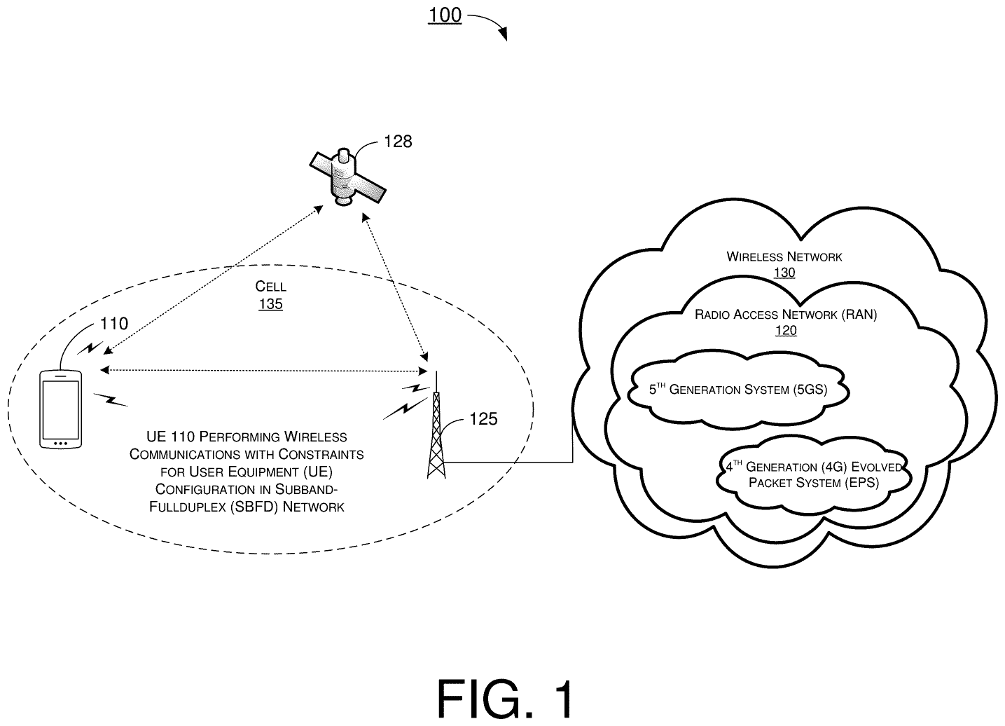

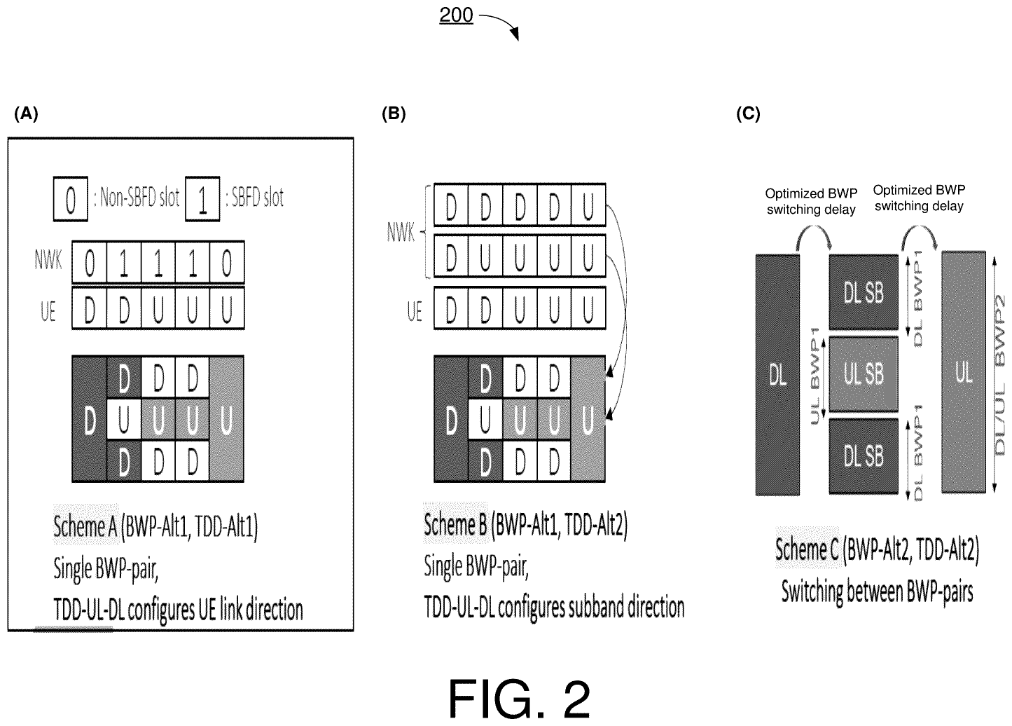

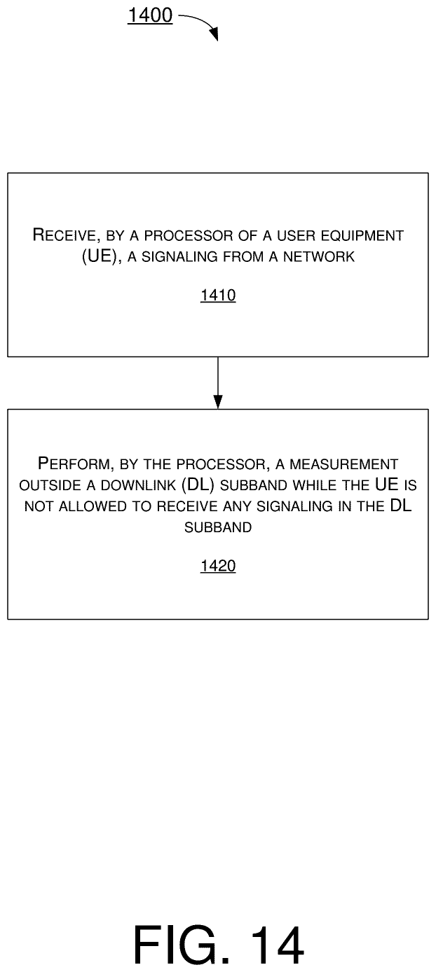

FIG. 1 illustrates an example network environment 100 in which various solutions and schemes in accordance with the present disclosure may be implemented. FIG. 2˜FIG. 14 illustrate examples of implementation of various proposed schemes in network environment 100 in accordance with the present disclosure. The following description of various proposed schemes is provided with reference to FIG. 1˜FIG. 14.

Referring to FIG. 1, network environment 100 may involve a UE 110 in wireless communication with a RAN 120 (e.g., a 5G NR mobile network or another type of network such as an NTN). UE 110 may be in wireless communication with RAN 120 via a terrestrial network node 125 (e.g., base station, eNB, gNB or transmit-and-receive point (TRP)) or a non-terrestrial network node 128 (e.g., satellite) and UE 110 may be within a coverage range of a cell 135 associated with terrestrial network node 125 and/or non-terrestrial network node 128. RAN 120 may be a part of a network 130. In network environment 100, UE 110 and network 130 (via terrestrial network node 125 and/or non-terrestrial network node 128) may implement various schemes pertaining to configuration of SBFD-aware UEs in mobile communications, as described below. It is noteworthy that, although various proposed schemes, options and approaches may be described individually below, in actual applications these proposed schemes, options and approaches may be implemented separately or jointly. That is, in some cases, each of one or more of the proposed schemes, options and approaches may be implemented individually or separately. In other cases, some or all of the proposed schemes, options and approaches may be implemented jointly.

FIG. 2 illustrates an example scenario 200 in accordance with the present disclosure. Under various proposed schemes in accordance with the present disclosure, there may be multiple framework options under consideration, namely Scheme A, Scheme B and Scheme C as shown in Parts (A), (B) and (C) of FIG. 2, respectively. Scheme A may be considered as the baseline in contrast with Schemes B and C. Scheme A may involve independent configurations of SBFD, TDD-UL-DL and BWP. Scheme B may involve SBFD being configured by TDD-UL-DL configuration per subband. Scheme C may involve SBFD being configured by multiple DL BWP pairs and multi-cluster BWP. There may be some fundamental choices with the schemes indicated in parentheses as follows: (a) BWP-Alt-1 (A, B): serving-cell-configuration level SBFD configuration in frequency+single BWP-pair allows SBFD operation as SBFD and non-SBFD slots/symbols alternate; (b) BWP-Alt-2 (C): BWP level SBFD configuration in frequency+pre-configured switching between BWP-pairs as SBFD and non-SBFD slots/symbols alternate; (c) TDD-Alt-1 (A, C): semi-static SBFD configurations are separate from semi-static TDD-UL-DL configurations; the latter select the UE link direction, i.e. whether UL or DL BWP is used; and (d) TDD-Alt-2 (B): semi-static TDD-UL-DL configurations per subband determine the link direction for the subband (possibly using SFI indication). The UE link direction is either selected by scheduling and the SBFD layout or by additional signalling.

It is noteworthy that several aspects may motivate the configuration enhancement that shares the SBFD layout knowledge with half-duplex (and SBFD-aware) UEs. One aspect is that knowledge of the frequency location of subbands may allow adaptive frequency domain resource allocations that prevent frequency domain resource fragmentations with FDRA Type-0, for instance, as detailed below. Another aspect is that knowledge of the time location of subbands may allow adaptive selection between resource sets (used in the resource selection) or resource parameters (e.g., transmit (Tx) power level, frequency offset, etc.). Still another aspect is that subband configurations may be used in intra-UE prioritization, in that: (a) de-prioritization of semi-statically scheduled transmission or reception may be triggered when the resource is not available in an SBFD- (non-SBFD-) slot/symbols because the allocated resources are assigned to non-SBFD- (SBFD-) slots/symbols exclusively; and (b) DL-UL switching points may be handled separately by each subband as explained in the sequel. It is noteworthy that SBFD layout may be separated into frequency-domain partitioning and a time-domain pattern indicating the time location of SBFD slots/symbols within a single carrier.

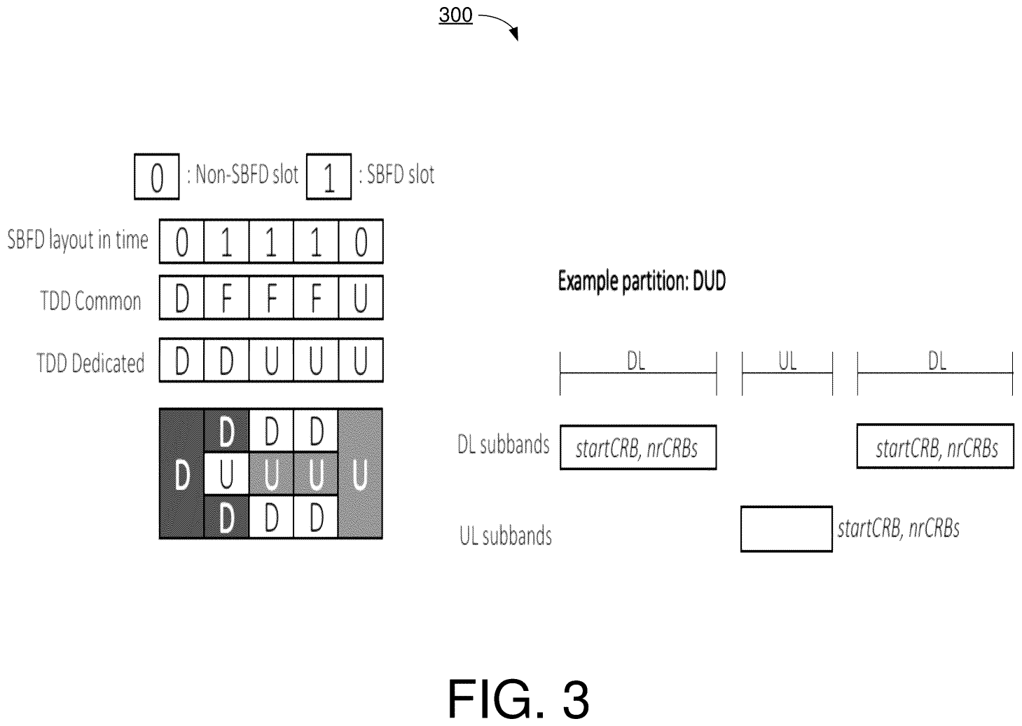

FIG. 3 illustrates an example scenario 300 of this scheme and its relationship to legacy TDD frame format configurations. For simplicity, only rough, slot-level configurations are indicated in FIG. 3. Referring to FIG. 3, an observation may be made that, by usage of SBFD partition information, UE behavior may be enhanced in: (a) adaptive FDRA allocations and signaling, and (b) handling UL-DL scheduling collisions.

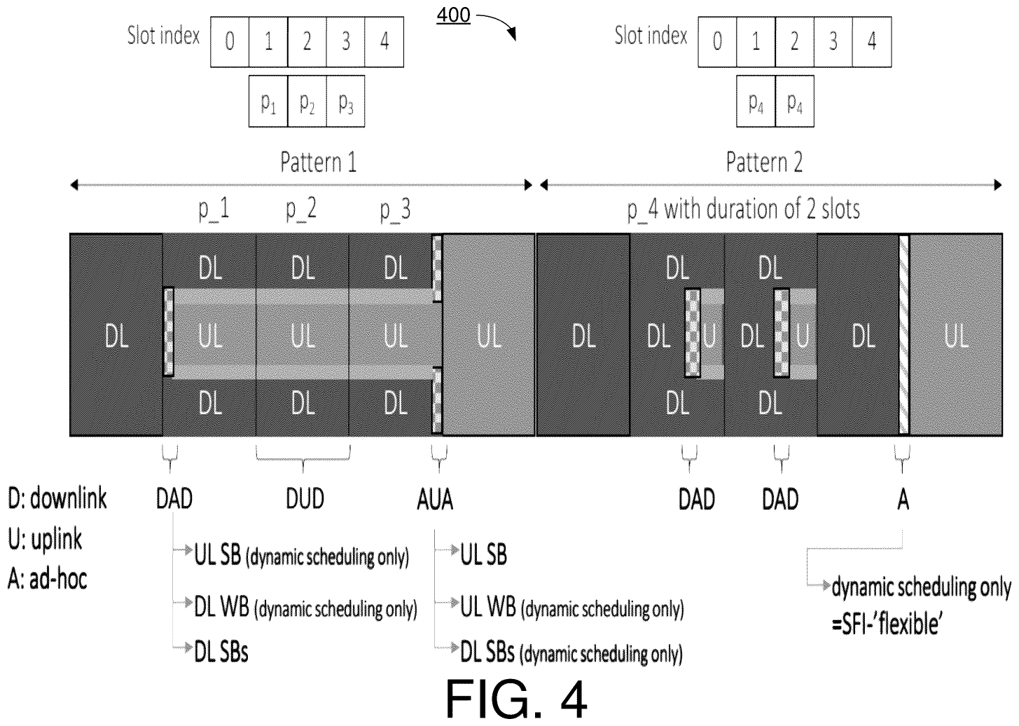

FIG. 4 illustrates an example scenario 400 of a more detailed SBFD layout. Specifically, FIG. 4 indicates the symbol level partitioning, p_1 through p_4 designating different symbol level patterns that occur within a slot. For the same reasons as in a TDD deployment, indication of ‘flexible’ symbols is necessary for directional collision handling where DL-UL switching occurs. These switching points may occur at different symbols for different subbands. By dedicated UE configurations different round-trip time (RTT) and timing advance (TA) may also be accommodated amongst UEs. Referring to FIG. 4, one observation may be made that, DL-UL switching points may occur in separate symbols per subband. This motivates per-subband, per-symbol indication RB-symbol regions reserved for DL-UL switching. In FIG. 4, ad-hoc symbols, or ad-hoc subbands within a symbol, have flexible link direction and only allow dynamic scheduling. This behavior corresponds to ‘flexible’ indication by SFI group common signaling. As specified in 3GPP Technical Specification (TS) 38.213, semi-statically configured transmission or reception may be deprioritized over these symbols: “if an SFI-index field value in DCI format 2_0 indicates the set of symbols of the slot as flexible, and the UE does not detect a DCI format indicating to the UE to receive PDSCH or CSI-RS, or the UE does not detect a DCI format, a RAR UL grant, fallbackRAR UL grant, or successRAR indicating to the UE to transmit PUSCH, PUCCH, PRACH, or SRS in the set of symbols of the slot, the UE does not transmit or receive in the set of symbols of the slot.”

It is noteworthy that it is necessary to distinguish symbols left ‘flexible’ by TDD-UL-DL-ConfigCommon and TDD-UL-DL-ConfigDedicated, which behave as if configuration was not provided at all, hence, best described as ‘Flexible-Uknown’, from symbols indicated as ‘flexible’ by SFI group common signaling, reserved to switching points or dynamic scheduling decisions, hence best described as ‘Flexible-Ad-hoc’, or simply ‘Ad-hoc’.

Another observation may be made that, in TDD frame format configuration by current specification, on symbols indicated as flexible by group common signaling, transmission or reception may be only carried out when scheduled dynamically. ‘Flexible-ad-hoc’ or simply ‘ad-hoc’ full symbols or subband symbols may also provide a means to dynamic scheduling decisions that override the semi-static SBFD partition layout applied in the network, which is generally aligned between multiple sectors and cells, in a similar way to synchronized TDD deployments. As indicated in FIG. 4, dynamic scheduling may have the option to treat ‘DAD’ symbols as unpartitioned DL symbol CDL WB′, standing for wideband), or transmit UL over the UL subband CUL SB′), or receive DL over the DL subband CDL SB′), whereas for semi-static scheduling only the DL subbands may be available for reception while any transmission over the UL subband is deprioritized. Meanwhile, indicating the full bandwidth of the symbol as ‘ad-hoc’ may provide full flexibility to dynamic scheduling and deprioritizes any semi-static scheduled transmission or reception, irrespective of the semi-static indication of SBFD partitioning. Any further flexibility for dynamic subband partition decisions may seem unnecessary, since the flexibility is on par with dynamic TDD scheduling restrictions.

According to the above rationale and necessary features, several schemes may be proposed. Firstly, a UE (e.g., UE 110) may be configured with periodic SBFD partition pattern through a system information block (SIB) and dedicated radio resource control (RRC) signaling, and there is no need for dynamic signaling of SBFD pattern. Secondly, semi-static configuration of the time locations where SBFD partitioning is applied may be signaled separately and in addition to legacy TDD-UL-DL configuration. Thirdly, on symbols indicated as flexible by slot-format indicator (SFI) group common signaling, the SBFD partition may be assumed to be unknown by the UE irrespective of other configurations. Fourthly, configuration of a subband within a symbol to be reserved to dynamically scheduled transmission or reception without restriction on the link direction may be supported, and such a subband is neither UL or DL, but ‘flexible’. Fifthly, transmission of physical uplink shared channel (PUSCH), physical uplink control channel (PUCCH), physical random access channel (PRACH) and sounding reference signal (SRS) may need to be confined within UL or flexible subband if the resource allocation overlaps with symbols of the slot indicated to be partitioned and contains strictly DL subband(s). Sixthly, reception of synchronization signal block (SSB), physical downlink control channel (PDCCH), physical downlink shared channel (PDSCH), channel status information reference signal (CSI-RS), phase tracking reference signal (PT-RS) may need to be confined within DL or flexible subband if the resource allocation overlaps with symbols of the slot indicated to be partitioned and contains strictly UL subband(s).

Thus, under a proposed scheme in accordance with the present disclosure, a UE (e.g., UE 110) may be configured with periodic SBFD partition pattern through SIB and dedicated RRC signaling. No need for dynamic signaling of SBFD pattern. Under the proposed scheme, semi-static configuration of the time locations where SBFD partitioning is applied may be signaled separately and in addition to legacy TDD-UL-DL configuration. Under the proposed scheme, on symbols indicated as flexible by SFI group common signaling, the SBFD partition status may be assumed to be unknown by UE, irrespective of other configurations. Additionally, under the proposed scheme, configuration of a subband within a symbol to be reserved to dynamically scheduled transmission or reception without restriction on the link direction may be supported, and such a subband may be neither UL or DL, but ‘flexible’. Moreover, under the proposed scheme, transmission of PUSCH, PUCCH, PRACH and SRS may be confined within UL or flexible subband if the resource allocation overlaps with symbols of the slot indicated to be partitioned and contains strictly DL subband(s). Furthermore, under the proposed scheme, reception of SSB, PDCCH, PDSCH, CSI-RS, PT-RS may be confined within DL or flexible subband if the resource allocation overlaps with symbols of the slot indicated to be partitioned and contains strictly UL subband(s).

Since UE-UE CLI mitigation can rely on measuring SRS-RSRP in the UL subband, inter-subband UE-UE CLI measurement may be possible over measurement resources not confined within the DL subband. Under a proposed scheme in accordance with the present disclosure, a SBFD-aware UE (e.g., UE 110) may not expect to be scheduled with UL transmission outside the UL subband or to be scheduled with DL reception within the UL subband in the SBFD symbol, with certain exceptions. One exception may be that there is no restriction on frequency-domain resource allocation (FDRA) and link direction if symbol or subband within a symbol is indicated to be ‘flexible’ by SBFD layout or group common SFI signaling of UE TDD link direction. Another exception may be that there is no restriction on frequency location of measurement resource without measurement gap. As the active BWP is switched between wide and narrow bandwidth, the availability of certain subbands may change as well. This may impact on the dedicated TDD configuration of the UE, which may be updated dynamically by using SFI group common signaling. However, the configuration of SBFD layout does not need to change if the frequency location of subbands is specified with respect to CRB #0. With this, SBFD layout in frequency and time may be configured per carrier as part of the serving cell configurations of the UE (as opposed to BWP level), as is the case with TDD-UL-DL-ConfigCommon and TDD-UL-DL-ConfigDedicated. This may provide a minimalist solution for SBFD configurations, which ensures consistency over different BWPs. Accordingly, under the proposed scheme, SBFD layout in frequency and time may be configured per carrier (as part of the serving cell configurations of the UE).

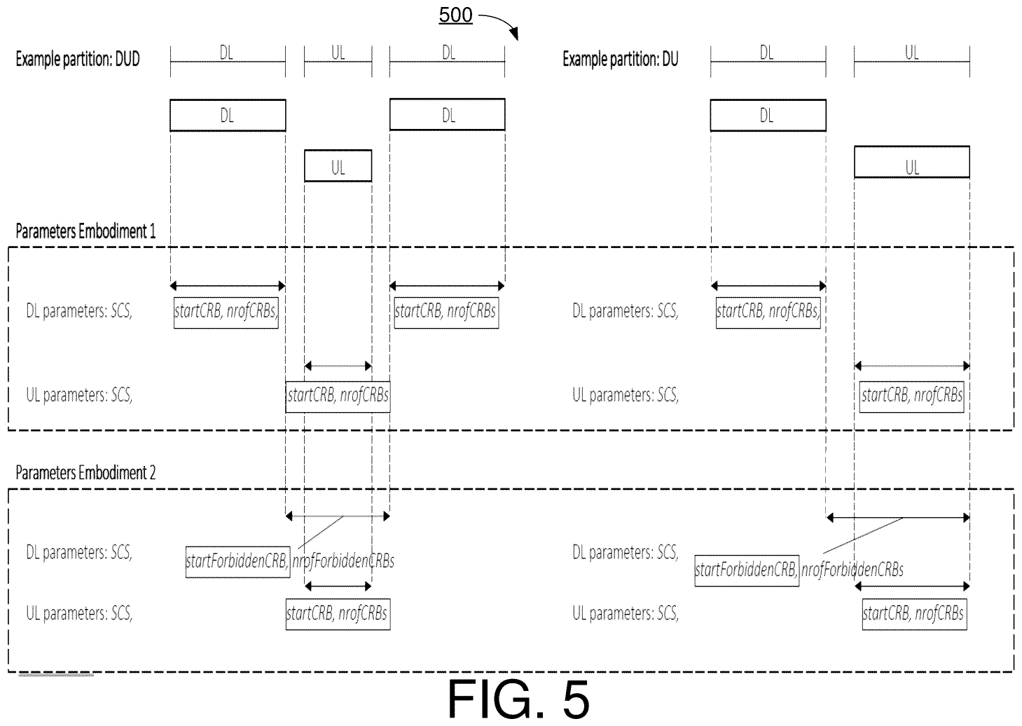

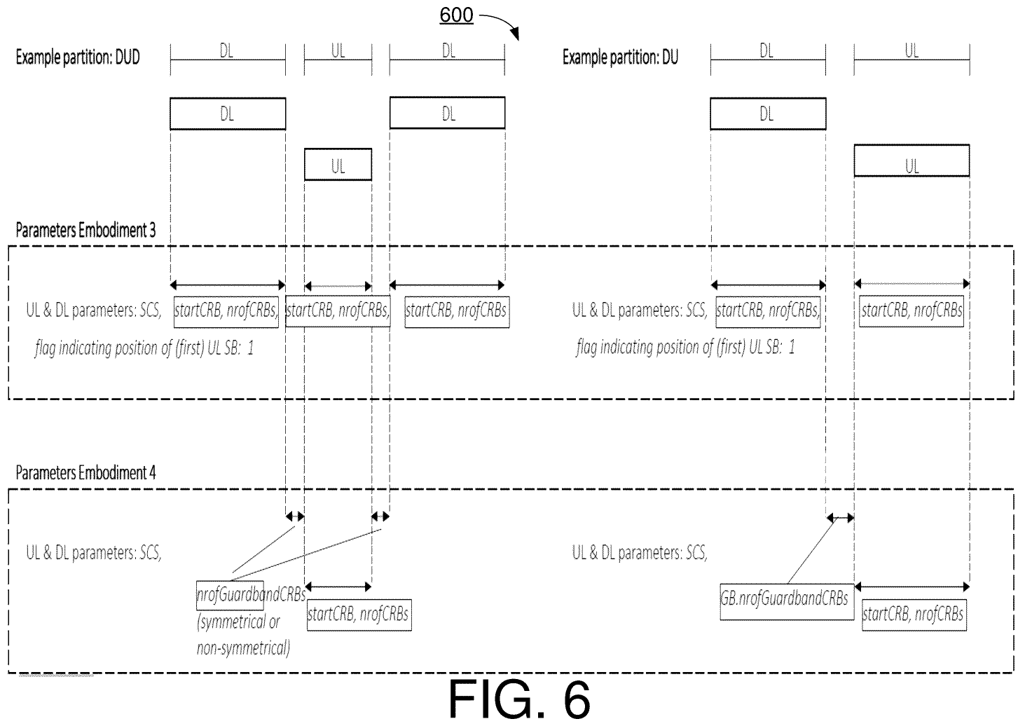

FIG. 5 and FIG. 6 illustrate example scenarios 500 and 600 under a proposed scheme in accordance with the present disclosure. Under the proposed scheme, with respect to SBFD frequency-domain subband partitioning, a network node (e.g., gNB) may configure one or multiple frequency-domain subband partitions per serving cell to the UE by higher layer signalling, where each partition consists of a set of UL subbands and a set of DL subbands where a subband consists of a set of one or more contiguous resource blocks (RBs). In one embodiment, the configuration may be broadcast as part of SIB signaling. In one embodiment, at most a single subband partition may be configured and used in all partitioned slots/symbols. In one embodiment, a partitioning may contain one UL subband and one or two DL subbands. The UL subband may be configured by specifying a subcarrier spacing (SCS) and the index of its first common resource block (CRB) and the RB size. The DL RB set(s) may be configured by specifying an SCS and a forbidden band specified by its first CRB and the RB size. This and alternative embodiments are shown in FIG. 5 and FIG. 6.

In an alternative embodiment, only UL subbands need to be configured explicitly, for example, by using startCRB, nrofCRBs for UL subbands or, alternatively, by using startForbiddenCRB, nrofForbiddenCRBs for gaps between uplink subbands. Here, DL allocations may be handled by existing specification features (e.g., FDRA Type-0 and RateMatchPattern, and so on). In an alternative embodiment, startCRB and nrofCRBs may be configured for each DL and UL subband. In one embodiment, SCS may be common between UL and DL. In one embodiment, SCS may be configured separately as part of serving cell or BWP configuration. In one embodiment, SCS may need to match between UL and DL. In one embodiment, the link direction may be unspecified, and all even subbands may have the same direction while all odd subbands may have the same direction. In one embodiment, a separate signaling may enable or disable the configured partitioning (or select between configured partitioning alternatives) per a set of symbols. When partitioning is disabled, the entire UE channel bandwidth may be either DL or UL as determined by one or more factors amongst multiple choices: (a) DL; (b) DL or UL according to the TDD-UL-DL-configuration applying to the set of symbols, if the configuration exists; (c) DL or UL according whether transmission or reception is scheduled dynamically on the set of symbols; and (d) DL or UL according to a binary flag configured as part of the partition configuration k.

Referring to FIG. 5, an advantage of one of the embodiments of the proposed scheme may be that the format does not change between DUD, UD, DU partitions, thereby reducing the standardization effort. However, if UDU is considered as well, then another embodiment under the proposed scheme may be preferred. Referring to FIG. 6, the same SCS may be assumed. In some of the embodiments, guard bands and their locations may be specified, plus a flag. Alternatively, or additionally, the UL subband and the left and right guard bands may be specified.

Regarding rate match patterns (RateMatchPatterns), there may be some advantages. For instance, there may be dynamic enabling/disabling mechanism supported for two RateMatchPatternGroups in the current 3GPP standard. Also, a RateMatchPattern may blank out physical resource block (PRB) fractions of code block groups (CBGs) allocated by Type 0 DL FDRA or specific symbols within a slot. However, there are also limitations associated with RateMatchPatterns. Firstly, overlap with Rate Match Pattern frequency-time RB region does not influence TBS calculation performed by scheduling. As a result, the effective code rate ends up being higher than the scheduled MCS. If the scheduler accounts for this, then this is not an issue. For repetitions, it is not desirable that TBS varies. Secondly, resource elements (REs) carrying a demodulation reference signal (DMRS) may not overlap with RMP regions. Furthermore, RateMatchPatten blanks out the respective PDSCH region irrespective whether it has been scheduled dynamically or semi-statically, thus it is not suitable to differentiate behaviours between these two cases.

Accordingly, several schemes are proposed to address aforementioned issues/limitations associated with RateMatchPatterns. Under a proposed scheme in accordance with the present disclosure, transport block size (TBS) calculation may account for overlap with regions blanked out by RateMatchPattern regions. In one embodiment, this may be a selectable option based on a new RRC field. Alternatively, or additionally, PDSCH DM-RS REs may be allowed to overlap partially with RE(s) that are not available for PDSCH mapping provided that these Res belong to PRBs that are not available in the entire PDSCH allocation. Optionally, the UE may expect that fractional PRB bundles are joined with the adjacent PRB bundle. Alternatively, or additionally, a group of RateMatchPattern may be enabled/disabled based on SBFD layout in time. For instance, a dedicated, third RateMatchPatternGroup may be introduced, which is enabled/disabled based on SBFD layout in time. Alternatively, or additionally, a RateMatchPattern may be configured to only apply to SPS PDSCH and not to dynamically scheduled 8 PDSCH.

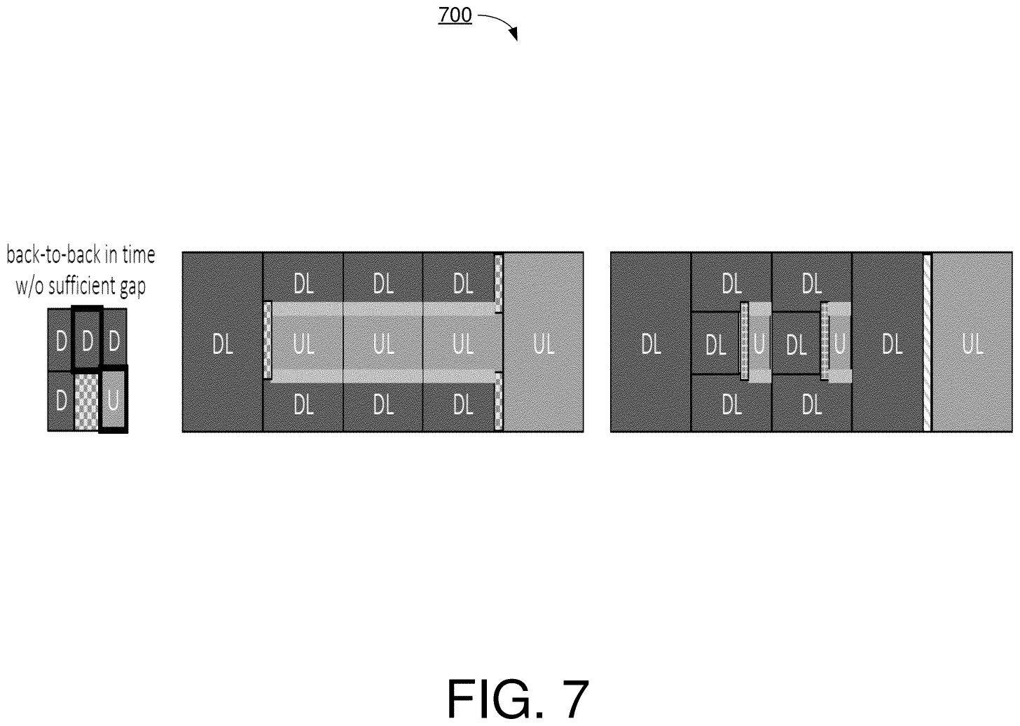

FIG. 7 illustrates an example scenario 700 with respect to symbol-level subband time location configuration. It is noteworthy that there may be motivation for symbol-level subband time location configurations. The purpose of symbol-level subband configurations may be multi-fold, including: (a) support of low-latency UL opportunities as in DTDD but within UL subbland; (b) support of UL TA; and (c) support of symbol-level granularity adjustment to the ratio between SBFD and non-SBFD symbols. A further technique may pertain to intra-UE prioritization rules (similar to HD FDD in reduced capability (RedCap)) to prioritize, for example, between transmission and reception scheduled back-to-back (bold frame shown on the left side of FIG. 7) without sufficient time gap for turn-around and TA.

Under a proposed scheme in accordance with the present disclosure, there may be some options with respect to semi-static (re-)configuration of SBFD layout in time and relationship to TDD. For instance, SBFD layout in time may be configured under the serving cell, and the behavior per BWP may be derived based on the same configuration. Alternatively, or additionally, the pattern length of SBFD layout in time may match that of TDD-UL-DL configuration (if it is provided). If TDD-UL-DL configuration is composed of two patterns back-to-back, then the SBFD layout in time may be composed of two patterns of matching lengths back-to-back, too. The same restrictions may apply to the pattern length(s) as in the case of TDD-UL-DL configurations. In one embodiment, SBFD layout may only be configured if TDD-UL-DL configuration is provided. In an alternative embodiment, there may be no such restriction. Under the proposed scheme, common SBFD layout in time may be configured by broadcast message as part of SIB. In one embodiment, on initial access the configurations may take effect when the UE enters RRC connected mode. In another embodiment, the configurations may take effect at the same time as the broadcasted TDD-UL-DL-ConfigurationCommon. Under the proposed scheme, UE-specific configuration of SBFD layout in time and/or frequency may be configured via RRC signaling. Alternatively, or additionally, only symbols belonging to the set of slots and symbols indicated as ‘flexible’ in the TDD-UL-DL-ConfigurationCommon—broadcasted as part of SIB—may be indicated as partitioned by the SBFD layout in time configured to the UE. Moreover, under the proposed scheme, if the TDD-DL-UL configuration of a set of symbols is indicated as ‘flexible’ by SFI signaling, then those symbols may be non-partitioned irrespective of any SBFD configuration. According to the current 3GPP specifications, any transmission or reception over these symbols may only take place when scheduled dynamically (e.g., by downlink control information (DCI) or random access response (RAR)).

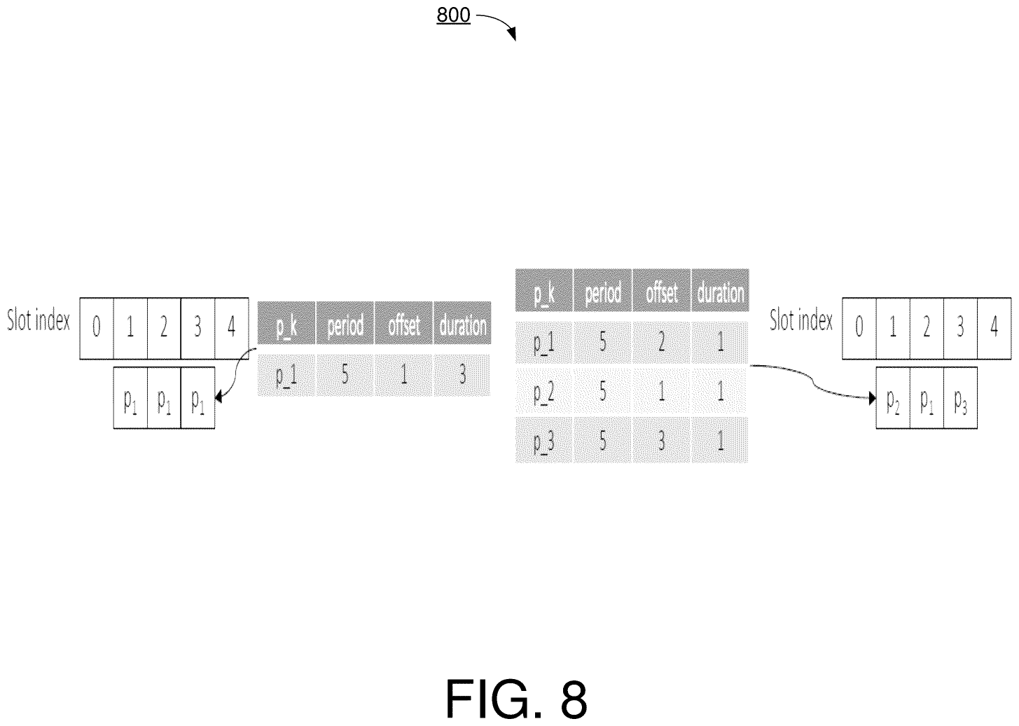

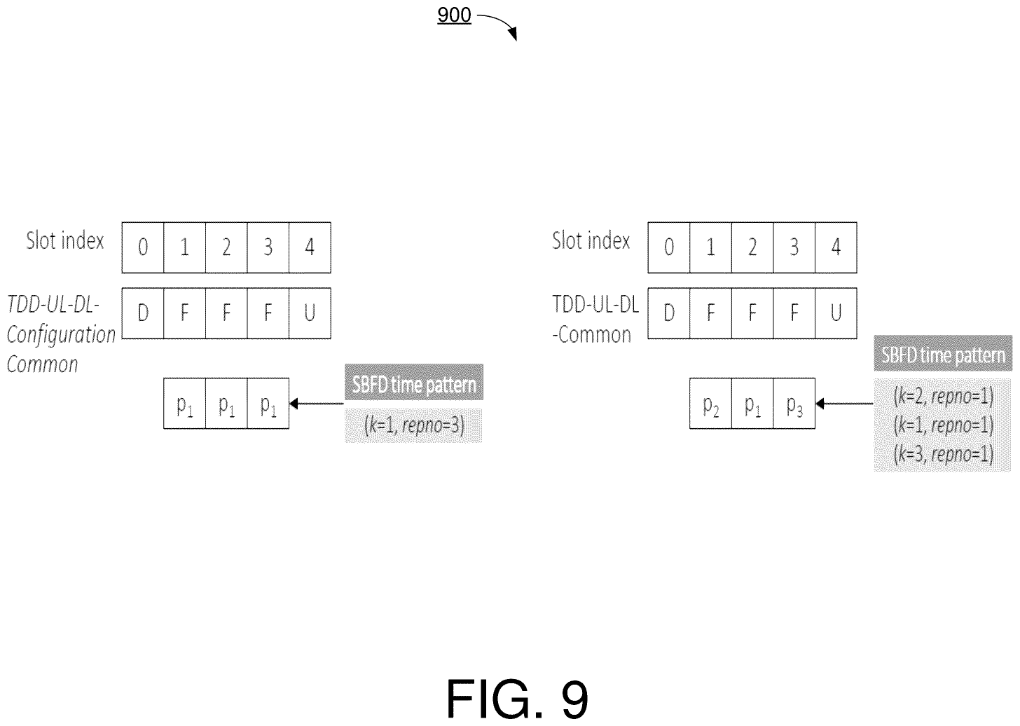

FIG. 8 and FIG. 9 illustrate example scenarios 800 and 900 under a proposed scheme in accordance with the present disclosure. Under the proposed scheme, there may be some options with respect to configuration format of SBFD layout in time. For instance, SBFD layout in time may be configured at a resolution of symbols. The same slot may contain a mix of SBFD and non-SBFD symbols in the UE configuration. Alternatively, or additionally, the SBFD layout in time may consist of a set of slot format configurations p_k (k=0, . . . ) describing the symbol locations within a slot where a particular configured subband partitioning is applied, on one hand, and a pattern determining the slot locations where each p_k is applied, on the other hand. In one embodiment, some of {p_k} may be predefined, for example, as a slot format where none of the symbols are partitioned in frequency and/or e.g. a slot format where all symbols are partitioned (according to a single/one of multiple subband partitioning configured to the UE). In one embodiment, SBFD layout may only be configured if TDD-UL-DL configuration is provided. In an alternative embodiment, there may be no such restriction. In one embodiment, if SBFD layout is not configured for a given set of symbols or the configuration does not indicate partitioning for them and if downlink or uplink is indicated for the set of symbols by TDD-UL-DL configuration, then the set of symbols may not be partitioned. That is, these symbols may be downlink-only or uplink-only or flexible according to the TDD-UL-DL configuration. In one embodiment, as shown in FIG. 8, the slot locations may be configured as a set of tuples {p_k, period, offset, duration}—or a subset thereof—where period, offset and duration specify slot locations as shown in FIG. 8. The period may be restricted to be an integer divisor of the pattern length, or not. It may be also possible that the period is omitted, and the offset may simply indicate the offset within the pattern. In one embodiment, the pattern may be composed of two separately configured patterns applied back-to-back.

In another embodiment as shown in FIG. 9, the slot locations for each p_k may be configured by giving the sequence of k indices in some concise format: e.g. (k₀, repno₀), (k₁, repno₁), (k₂, repno₂), . . . , where repnₒⱼ denotes the number of repetitions of index kⱼ in the sequence. Further simplifications or restrictions to this format may be not excluded either. For instance, in one embodiment, the SBFD time sequence configured by SIB may be limited to the sequence of Flexible slots in the TDD-UL-DL-ConfigurationCommon.

Alternatively, or additionally, the SBFD time sequence configured by dedicated RRC configuration may be limited to the sequence of ‘Flexible’ slots in the TDD-UL-DL-ConfigurationCommon. Alternatively, or additionally, partitioned slots configured by SIB may be limited to the sequence of Flexible slots in the TDD-UL-DL-ConfigurationCommon. Alternatively, or additionally, partitioned slots configured by dedicated RRC configuration may be limited to the sequence of ‘Flexible’ slots in the TDD-UL-DL-ConfigurationCommon Alternatively, or additionally, k=0 may be reserved for non-partitioned slot (e.g., no SBFD partitioned symbols in slot).

In another embodiment, for the set of slots indicated as ‘Flexible’ in TDD-UL-DL-ConfigurationCommon, the SBFD configuration in time may provide a sequence of configurations as to how many times a partition format repeats itself in entire slots or in symbols after last symbol of the previous configuration in the sequence, the first configuration starting with the first symbol. Here, a partition format may indicate one out of a subset of the following categories: (a) non-partitioned symbol; (b) non-partitioned ad-hoc symbol; (c) partitioned between downlink and uplink subbands; (d) partitioned between downlink and ad-hoc subbands; (e) partitioned between uplink and ad-hoc subbands. Here, ad-hoc subband may involve behavior as described below and may also indicate the specific subband partitioning if more than one can be configured to the UE.

Under the proposed scheme, in one embodiment, a subband in a symbol may be configured to indicate that transmission or reception is only allowed overlapping the subband when it is scheduled dynamically (by DCI or RAR UL grant), otherwise it may be deprioritized. Such subband in a symbol may be called ‘ad-hoc’ or ‘flexible.’ This may Involve that semi-statically scheduled transmission/reception/measurement to be deprioritized in case of overlap with the involved resource elements (REs). In one embodiment, link direction by dynamic scheduling may not need to match the original direction of the subband in ad-hoc subbands. Under the proposed scheme, the UE may be configured with a set of slot configurations p_k (with k=0, . . . ) describing which symbol locations within a slot are partitioned—also indicating the specific subband partitioning if more than one can be configured—and how the scheduling is limited in each subband (e.g., downlink/uplink/flexible subband). In one embodiment, p_k may be configured as two indices based on the 3GPP standardized SFI slot formats. One of the indices may apply to the downlink subband(s), and the other may apply to the uplink subband(s). In case that the link direction matches for all subbands, then the symbol may not be partitioned. In case that a symbol within a subband is ‘Flexible’, then it may be considered to be reserved for ‘ad-hoc’ scheduling decisions as described above. In another embodiment, p_k may be configured as sequence of length [N=number of symbols in a slot], where each element configures the respective symbol of the slot either as non-partitioned, or as partitioned between downlink and uplink. In another embodiment, p_k may be configured as sequence of length [N=number of symbols in a slot], where each element configures the respective symbol of the slot as one of the categories listed as described below.

Under the proposed scheme, when the same subband partition is applied in all partitioned symbols, the configuration of a symbol may indicate one out of a subset of the following categories: (1) non-partitioned symbol; (2) non-partitioned ad-hoc symbol; (3) partitioned between downlink and uplink subbands; (4) partitioned between downlink and ad-hoc subbands; and (5) partitioned between uplink and ad-hoc subbands. Here, ad-hoc subband may involve behavior as described above. In one embodiment, this proposal may be combined with an above-described embodiment in that any symbol indicated as Flexible by TDD-UL-DL SFI configuration may become a non-partitioned ad-hoc symbol. In one embodiment, only categories (1) and (2) may be allowed. In another embodiment, categories (1), (3) and (4) may be allowed. In yet another embodiment, categories (1), (2), (3) and (4) may be allowed. In yet another embodiment all five categories may be allowed. Further combinations in other embodiments may be not precluded. It is noteworthy that ad-hoc subbands are used to protect against inter-UE or inter-BS collisions at receive-to-transmit (Rx-to-Tx) turn around points. Also, for different subbands, the turn-around point may occur at different symbol boundaries in possibly different slots.

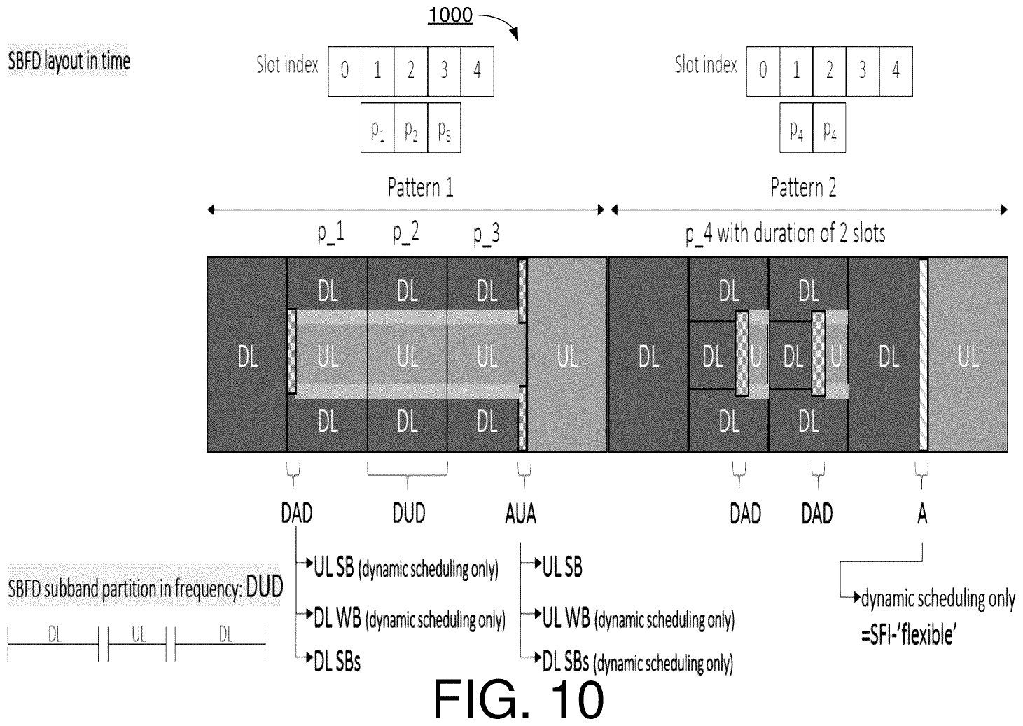

FIG. 10 illustrates an example scenario 10000 under a proposed scheme in accordance with the present disclosure. Under the proposed scheme, with respect to configuration format of SBFD layout in time, there may be complementary techniques to avoid inter-UE (and intra-UE) collisions. Notably, there are complementary techniques to avoid inter-UE and intra-UE collisions. In Release 15 of the 3GPP specification, one technique may pertain to dynamically (via SFI) signaled ‘Flexible’ symbol (striped pattern shown in FIG. 10) in TDD having the effect of deprioritizing dedicated, semi-statically configured transmission or reception in the entire BWP bandwidth. Another technique may pertain to semi-statically configured ‘Ad-hoc’ symbol (chess-board pattern shown in FIG. 10) confined in UL or DL sub-band, having the effect of deprioritizing dedicated, semi-statically configured transmission/reception in that subband. At the last symbols of DL subband (without demodulation reference signal (DMRS)), RateMatchPattern may also be used with PDSCH transmissions (and their repetitions).

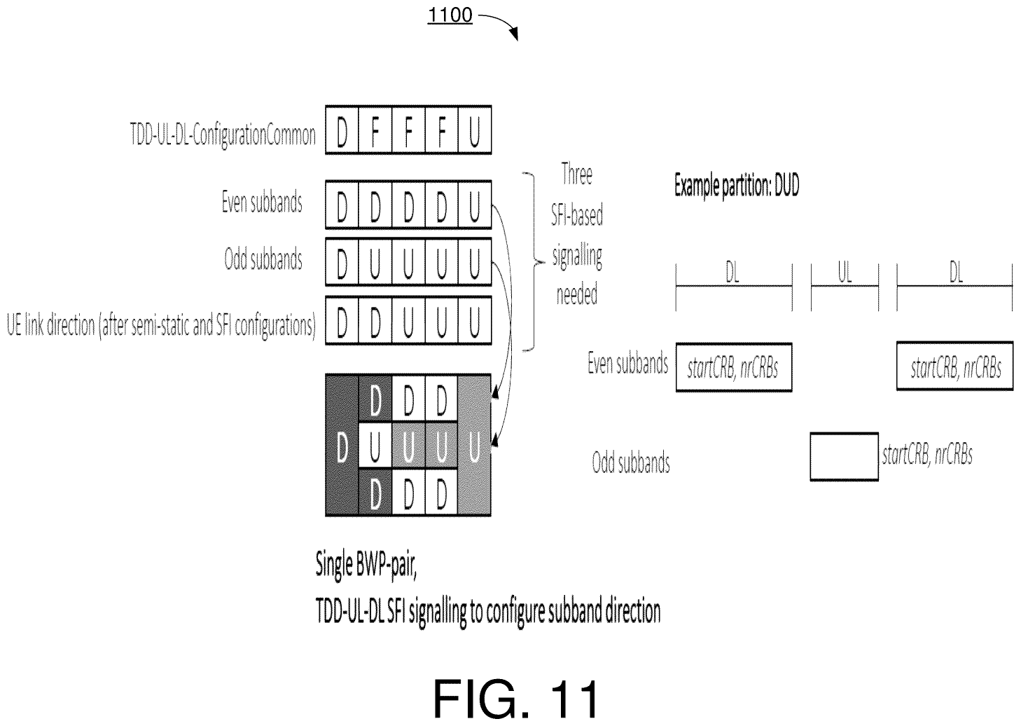

FIG. 11 illustrates an example scenario 11000 under a proposed scheme in accordance with the present disclosure. Under the proposed scheme, with respect to configuration format of SBFD layout in time, TDD-UL-DL SFI signaling used for UE link direction configuration may be replicated for configuring the link direction over even subbands and the link direction over odd subbands in the frequency domain subband partition, as described above. If the link direction matches for all subbands, then the symbol may be not partitioned and has the indicated direction. If a subband is ‘Flexible’, then it may be considered to be reserved for ‘ad-hoc’ scheduling decisions as described above. In one embodiment, the combination of link directions may be restricted to one particular uplink-downlink partitioning. In one embodiment the, UE may be configured with SFI slot combinations and group common DCI (GC-DCI) position pointers for the configuration of even subbands and for the configuration of odd subbands. In one embodiment, the SFI signaling may not conflict with TDD and SBFD configurations broadcasted as part of SIB or carried out via dedicated RRC signalling.

Regarding back-to-back scheduling without sufficient gap between UL and DL, reception in a downlink symbol immediately followed by UL transmission in the next symbol by the same UE may cause intra-subband collision. This is because, due to TA, these symbols overlap in physical time from the perspective of the UE, which also requires an additional guard gap for Rx-Tx turn-around. In the description below, [N_{Rx-TX}·T_{c}] may be replaced by other values in embodiments that apply with the following proposals. Under a proposed scheme in accordance with the present disclosure, a half-duplex UE operating in SBFD cell may be not expected to transmit in the uplink earlier than [N_{RX-TX}·T_{c}] after the end of the last received downlink symbol in the same cell. If the condition is violated, then there may be a collision case similar to overlapping symbols. Alternatively, or additionally, a half-duplex UE operating in SBFD cell maybe not expected to receive in the downlink earlier than [N_{RX-TX}·T_{c}] after the end of the last transmitted uplink symbol in the same cell. If the condition is violated, then there may be a collision case similar to overlapping symbols. Alternatively, or additionally, in case that a dynamically scheduled DL collides with semi-static UL, the half-duplex UE may apply intra-UE prioritization as defined in Release 15 and/or Release 16 of the 3GPP specification(s). Alternatively, or additionally, in case that a dynamically scheduled UL (PUSCH, PUCCH, SRS, or PRACH triggered by PDCCH) collides with semi-static DL (PDCCH, SPS PDSCH, CSI-RS or PRS), then the half-duplex UE may apply intra-UE prioritization as defined in Release 15 and/or Release 16 of the 3GPP specification(s). Alternatively, or additionally, a half-duplex UE in an SBFD cell may be not expected to receive the following: (1) a dedicated RRC configuring transmission from the UE and a dedicated RRC configuring reception in the same set of symbols; and/or (2) a dedicated RRC configuring transmission from the UE and a cell-specific RRC configuring reception in the same set of symbols; and/or (3) a cell-specific RRC configuring transmission from the UE and a dedicated RRC configuring reception in the same set of symbols. Alternatively, or additionally, in case that a valid PRACH occasion (including the preceding gaps specified in the 3GPP standard) collides with a downlink reception, then it may be UE implementation to decide which one is prioritized.

It is noteworthy that, in general, the problem of selection between two resource allocation (RA) configuration alternatives tends to be common to all solutions of partitioning. There needs to be differentiated behavior(s) with and without subband partitioning. There also needs to be signaling and/or rule to select between different behaviors. To address these needs for the configurations necessary for differentiated behaviors, there may be several options under a proposed scheme in accordance with the present disclosure with respect to alternative RA over SBFD slots/symbols. In a first option (Option-1), pertaining to transparent mode and also legacy UEs, FDRA signaling may be the same and the allocated PHY channel resource sets (e.g., PUCCH Resource Sets) may be shared between SBFD and non-SBFD slots/symbols. From the same resource set different resources may be selected by scheduling based on the partitioning. This is the method that can be used by legacy UEs, but this may also be the case with enhanced UEs. In a second option (Option-2), a modified FDRA (Type-0) behavior reusing existing signaling may be utilized (e.g., scheduling fraction of code block groups (CBGs) at subband boundaries. In a third option (Option-3), the resource (e.g., PUCCH) may have a field that maps the resource to a subband and may be only transmitted/received if that subband is available. Alternatively, it may have a field that maps the resource to one or multiple SBFD partition options and, if the configuration of the slot matches any of the SBFD partition options in the field, then the PUCCH may be transmitted; otherwise it may be deprioritized. As an example, the field value from {SBFD, non-SBFD} may be reserved to SBFD or reserved to non-SBFD symbols. As another example, the field value from {SBFD, non-SBFD, either} may indicate no restriction. In a fourth option (Option-4), alternative resource sets may be configured, which may be selected depending on the SBFD partitioning. The selection may be governed by rules based on SBFD layout configuration or based on dynamic signaling. For example, in case that SBFD and non-SBFD slots are handled by switching between separate BWP pairs, then the resource configurations may change along with the selected BWP pair. In case that partitioning is not defined for some/all symbols belonging to an allocation, then a rule or a DCI field may be utilized to resolve the ambiguity arising in Option-2, 3 or 4.

Under a proposed scheme in accordance with the present disclosure with respect to alternative resource allocation over SBFD slots/symbols, a new DCI field may be introduced to select between resource allocation alternatives configured to be used over partitioned and non-partitioned slots/symbols. In one embodiment, dedicated RRC configuration may indicate whether the field is present or not in the DCI. Separate field may be used per DCI_1_1, DCI_1_2, DCI_0_1, DCI_0_2. In an alternative embodiment, dedicated RRC configuration may indicate whether the field is present or not in the DCI. The same field may be used per DCI_1_1, DCI_1_2, DCI_0_1, DCI_0_2. In another embodiment, it may be fixed for which DCIs the field is present. In one embodiment, with the fallback DCI (DCI_1_0 or DCI_0_0) the behavior may be the same as if non-partitioned symbols were indicated. In one embodiment, a binary field may govern the selection for multiple physical channels out of the set PUSCH, PDSCH, CSI-RS, SRS, PRACH. In one embodiment, the field may be applied to enable fractional CBG allocation at subband boundaries when PDSCH is scheduled with FDRA Type-0. In one embodiment, the field may be applied to enable fractional CBG allocation at subband boundaries when PUSCH is scheduled with FDRA Type-0. In one embodiment, the field may be applied to enable different SLIV calculation and/or interleaving behaviour based on subband boundaries when PDSCH is scheduled with FDRA Type-1. In one embodiment, the field may be applied to enable different SLIV calculation and/or frequency-hopping behaviour based on subband boundaries when PUSCH is scheduled with FDRA Type-1. In one embodiment, the field may be applied to select between separate resource allocations when CSI-RS is scheduled. In one embodiment, the field may be applied to select between separate resource allocations when SRS is scheduled dynamically. In one embodiment, the field may be applied to select between separate resource allocations when PRACH is scheduled dynamically. Under the proposed scheme, a new DCI field may be introduced to signal when it schedules a reception over an uplink-subband or a transmission over a downlink-subband. Resource allocation in these cases may assume that no subband partition is used. In one embodiment, the same bit may be utilized. In an alternative embodiment, a dedicated field may be used. In one embodiment, the signaling may be also introduced with RAR UL grant and successRAR.

Under the proposed scheme, a new DCI_1_1/1_2 field may be introduced to indicate whether PDSCH repetitions scheduled by the DCI (or SPS PDSCH transmissions configured with repetitions and enabled by the DCI) should be skipped or postponed when repetitions overlap with symbols having different partitioning than the first instance in the series of repetitions. In one embodiment, if the bit is not set, then repetitions may carry on over SBFD and non-SBFD slots/symbols alike. However, when the bit is set and the first instance is scheduled on a non-SBFD (e.g., DL-only) slot/symbols, then the repetitions may be skipped or postponed (as defined by other rules or configurations) when it would fall on SBFD slot/symbols and, vice versa. When the bit is set and the first instance is scheduled on a SBFD slot/symbols, then the repetition may be skipped or postponed (as defined by other rules or configurations) when it would fall on non-SBFD slot/symbols (e.g., DL-only slot/symbols). In one embodiment, an RRC field may indicate whether the new DCI_1_1 field is present or not. In one embodiment, an RRC field may indicate whether the new DCI_1_2 field is present or not. In one embodiment, the new field may be only introduced with DCI_1_1. In one embodiment, given the behavior with fallback DCI 1_0, the behavior may match the behavior with the field unset. In one embodiment, given the behavior with fallback DCI 1_0, the behavior may match the behavior with the field set. In one embodiment, the partitions may be configured by BWP pairs and switching between partitions may switch the BWP.

Under the proposed scheme, a new DCI_0_1/0_2 field may be introduced to indicate whether PUSCH repetitions scheduled by the DCI should be skipped or postponed when repetitions overlap with symbols having different partitioning than the first instance in the series of repetitions. In one embodiment, if the bit is not set, then repetitions may carry on over SBFD and non-SBFD slots/symbols alike. However, when the bit is set and the first instance is scheduled on a non-SBFD (e.g., DL-only) slot/symbols, then the repetitions may be skipped or postponed (as defined by other rules or configurations) when it would fall on SBFD slot/symbols and, vice versa. When the bit is set and the first instance is scheduled on a SBFD slot/symbols, then the repetition may be skipped or postponed (as defined by other rules or configurations) when it would fall on non-SBFD slot/symbols (e.g., DL-only slot/symbols). In one embodiment, an RRC field may indicate whether the new DCI_0_1 field is present or not. In one embodiment, an RRC field may indicate whether the new DCI_0_2 field is present or not. In one embodiment, the new field may be only introduced with DCI_0_1. In one embodiment, given the behavior with fallback DCI 0_0, the behavior may match the behaviour with the field unset. In one embodiment, given the behavior with fallback DCI 0_0, the behavior may match the behaviour with the field set. In one embodiment, the partitions may be configured by BWP pairs and switching between partitions may switch the BWP.

Under a proposed scheme in accordance with the present disclosure, with respect to measurement outside the DL subband, UE-UE CLI measurement resource in partitioned slots/symbols may be configured outside the DL subband, even if the UE is not allowed to receive anything else (e.g., PDCCH, PDSCH, CSI-RI and so forth) outside the downlink subband. Alternatively, or additionally, the UE may be configured with CSI-RS measurement outside the DL subband, even if the UE is not allowed to receive PDCCH or PDSCH outside the downlink subband.

Under a proposed scheme in accordance with the present disclosure, with respect to BWP-based partitioning, the same timing advance may be used in partitioned and non-partitioned slots/symbols, throughout the SBFD layout configuration. In one embodiment, the SBFD layout may be configured by the method based on a single BWP pair, as in the previous proposals. In one embodiment, the SBFD layout may be configured by the method based on a switching between multiple BWP pairs, as in the proposals below. Under the proposed scheme, the SBFD layout in frequency may be configured as part of the configuration of BWP pairs, and layout in frequency may be configured by a periodic pattern of switching between these BWP pairs. The number of BWP pairs that can be switched in-between may be limited to two pairs, configured with the same numerology and cyclic prefix (CP) length. The switching may start and/or finish on a symbol boundary that is not a slot boundary. The switching pattern may be configured as part of serving cell UE configurations. The switching may be enabled by the configuration. The pattern lengths may be aligned with the TDD-UL-DL common configurations, if such information is provided. The switching schedule may configure the slot and symbol where the switching starts. The BWPs may be configured to contain a non-contiguous set of physical resource blocks (PRBs). In one embodiment, both UL BWP and DL BWP may be configured to contain a non-contiguous PRBs. In one embodiment, only DL BWP may be configured to contain a non-contiguous PRBs. In one embodiment, the number of non-contiguous set of PRBs may be limited to two. Under the proposed scheme, the switching duration specific to the case of periodic switching may be a UE capability reported by the UE and may be defined at the resolution of symbols. In one embodiment, type-1, type-2, etc. capability may be reported by the UE, where the type may define the duration per numerology (or a subset thereof). Under the proposed scheme, a field configured by RRC (in the case of semi-static scheduling) or contained by DCI (in the case of dynamic scheduling) may indicate whether repetitions are skipped when the BWP is switched by the periodic switching method. In one embodiment, skipping may involve postponing the current repetition. In one embodiment, skipping may involve dropping the current repetition.

### Illustrative Implementations

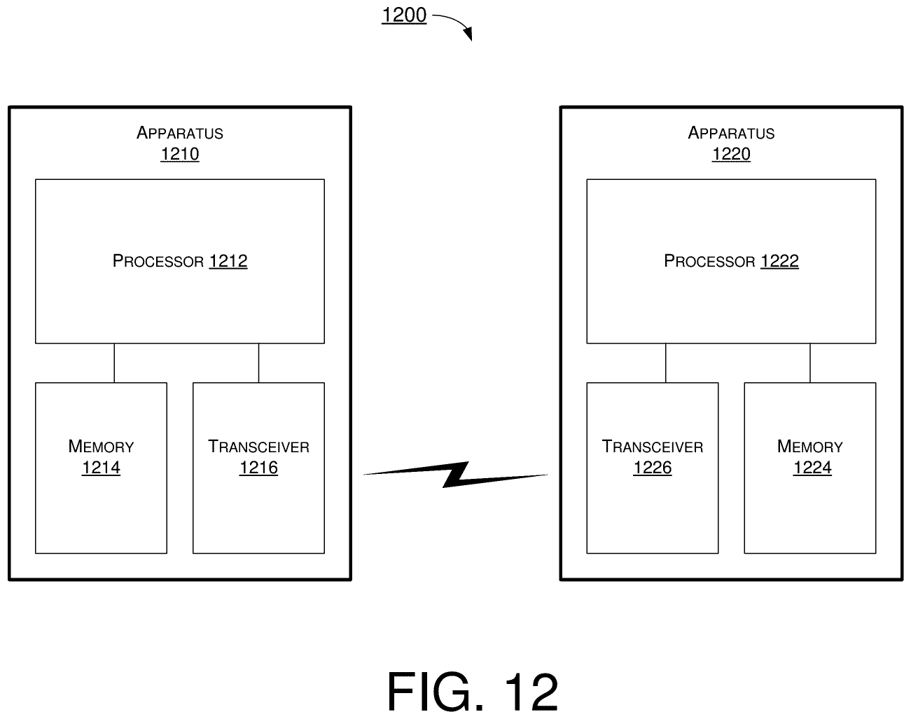

FIG. 12 illustrates an example communication system 1200 having at least an example apparatus 1210 and an example apparatus 1220 in accordance with an implementation of the present disclosure. Each of apparatus 1210 and apparatus 1220 may perform various functions to implement schemes, techniques, processes and methods described herein pertaining to configuration of SBFD-aware UEs in mobile communications, including the various schemes described above with respect to various proposed designs, concepts, schemes, systems and methods described above, including network environment 100, as well as processes described below.

Each of apparatus 1210 and apparatus 1220 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 1210 and apparatus 1220 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 1210 and apparatus 1220 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 1210 and apparatus 1220 may be implemented in a smart thermostat, a smart fridge, a smart door lock, a wireless speaker or a home control center. When implemented in or as a network apparatus, apparatus 1210 and/or apparatus 1220 may be implemented in an eNodeB in an LTE, LTE-Advanced or LTE-Advanced Pro network or in a gNB or TRP in a 5G network, an NR network or an IoT network.

In some implementations, each of apparatus 1210 and apparatus 1220 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 1210 and apparatus 1220 may be implemented in or as a network apparatus or a UE. Each of apparatus 1210 and apparatus 1220 may include at least some of those components shown in FIG. 12 such as a processor 1212 and a processor 1222, respectively, for example. Each of apparatus 1210 and apparatus 1220 may further include one or more other components not pertinent to the proposed scheme of the present disclosure (e.g., internal power supply, display device and/or user interface device), and, thus, such component(s) of apparatus 1210 and apparatus 1220 are neither shown in FIG. 12 nor described below in the interest of simplicity and brevity.

In one aspect, each of processor 1212 and processor 1222 may be implemented in the form of one or more single-core processors, one or more multi-core processors, or one or more CISC or RISC processors. That is, even though a singular term “a processor” is used herein to refer to processor 1212 and processor 1222, each of processor 1212 and processor 1222 may include multiple processors in some implementations and a single processor in other implementations in accordance with the present disclosure. In another aspect, each of processor 1212 and processor 1222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1212 and processor 1222 is a special-purpose machine specifically designed, arranged and configured to perform specific tasks including those pertaining to configuration of SBFD-aware UEs in mobile communications in accordance with various implementations of the present disclosure.

In some implementations, apparatus 1210 may also include a transceiver 1216 coupled to processor 1212. Transceiver 1216 may be capable of wirelessly transmitting and receiving data. In some implementations, transceiver 1216 may be capable of wirelessly communicating with different types of wireless networks of different radio access technologies (RATs). In some implementations, transceiver 1216 may be equipped with a plurality of antenna ports (not shown) such as, for example, four antenna ports. That is, transceiver 1216 may be equipped with multiple transmit antennas and multiple receive antennas for multiple-input multiple-output (MIMO) wireless communications. In some implementations, apparatus 1220 may also include a transceiver 1226 coupled to processor 1222. Transceiver 1226 may include a transceiver capable of wirelessly transmitting and receiving data. In some implementations, transceiver 1226 may be capable of wirelessly communicating with different types of UEs/wireless networks of different RATs. In some implementations, transceiver 1226 may be equipped with a plurality of antenna ports (not shown) such as, for example, four antenna ports. That is, transceiver 1226 may be equipped with multiple transmit antennas and multiple receive antennas for MIMO wireless communications.

In some implementations, apparatus 1210 may further include a memory 1214 coupled to processor 1212 and capable of being accessed by processor 1212 and storing data therein. In some implementations, apparatus 1220 may further include a memory 1224 coupled to processor 1222 and capable of being accessed by processor 1222 and storing data therein. Each of memory 1214 and memory 1224 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 1214 and memory 1224 may include a type of read-only memory (ROM) such as mask ROM, programmable ROM (PROM), erasable programmable ROM (EPROM) and/or electrically erasable programmable ROM (EEPROM). Alternatively, or additionally, each of memory 1214 and memory 1224 may include a type of non-volatile random-access memory (NVRAM) such as flash memory, solid-state memory, ferroelectric RAM (FeRAM), magnetoresistive RAM (MRAM) and/or phase-change memory.

Each of apparatus 1210 and apparatus 1220 may be a communication entity capable of communicating with each other using various proposed schemes in accordance with the present disclosure. For illustrative purposes and without limitation, a description of capabilities of apparatus 1210, as a UE (e.g., UE 110), and apparatus 1220, as a network node (e.g., network node 125) of a network (e.g., network 130 as a 5G/NR mobile network), is provided below in the context of example processes 1300 and 1400.

### Illustrative Processes

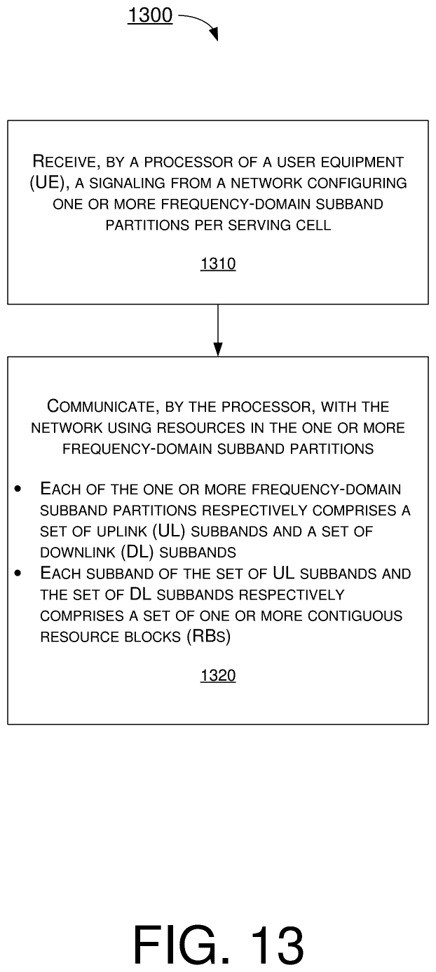

FIG. 13 illustrates an example process 1300 in accordance with an implementation of the present disclosure. Process 1300 may represent an aspect of implementing various proposed designs, concepts, schemes, systems and methods described above, whether partially or entirely, including those pertaining to those described above. More specifically, process 1300 may represent an aspect of the proposed concepts and schemes pertaining to configuration of SBFD-aware UEs in mobile communications. Process 1300 may include one or more operations, actions, or functions as illustrated by one or more of blocks 1310 and 1320. Although illustrated as discrete blocks, various blocks of process 1300 may be divided into additional blocks, combined into fewer blocks, or eliminated, depending on the desired implementation. Moreover, the blocks/sub-blocks of process 1300 may be executed in the order shown in FIG. 13 or, alternatively, in a different order. Furthermore, one or more of the blocks/sub-blocks of process 1300 may be executed iteratively. Process 1300 may be implemented by or in apparatus 1210 and apparatus 1220 as well as any variations thereof. Solely for illustrative purposes and without limiting the scope, process 1300 is described below in the context of apparatus 1210 as a UE (e.g., UE 110) and apparatus 1220 as a network node or base station (e.g., terrestrial network node 125 or non-network node 128) of a network (e.g., network 130 as a 5G/NR mobile network). Process 1300 may begin at block 1310.

At 1310, process 1300 may involve processor 1212 of apparatus 1210 receiving, via transceiver 1216, a signaling from a network (e.g., network 130 via apparatus 1220) configuring one or more frequency-domain subband partitions per serving cell. Process 1300 may proceed from 1310 to 1320.

At 1320, process 1300 may involve processor 1212 communicating, via transceiver 1216, with the network using resources in the one or more frequency-domain subband partitions. Each of the one or more frequency-domain subband partitions may respectively include a set of UL subbands and a set of DL subbands. Moreover, each subband of the set of UL subbands and the set of DL subbands may respectively include a set of one or more contiguous RBs.

In some implementations, the signaling may include a RRC signaling that configures a UE-specific SBFD layout in time, in frequency, or in both time and frequency.

In some implementations, the signaling may further configure an SBFD layout in time under a serving cell.

In some implementations, a pattern length of the SBFD layout in time may match that of a TDD-UL-DL configuration.

In some implementations, the TDD-UL-DL configuration may include respective two patterns back-to-back and the SBFD layout may also include respective two patterns of matching lengths back-to-back.

In some implementations, one or more symbols belonging to a set of slots and symbols indicated as ‘flexible’ in the TDD-UL-DL configuration may be indicated as partitioned by the SBFD layout in time configured to the UE.

In some implementations, responsive to a set of slots and symbols being indicated as ‘flexible’ in the TDD-UL-DL configuration by an SFI signaling, one or more symbols belonging to the set of slots and symbols may be non-partitioned irrespective the SBFD configuration.

In some implementations, the SBFD layout in time may include a common SBFD layout in time that is configured by a broadcast message as part of an SIB.

In some implementations, the SBFD layout in time may be configured at a resolution of symbols such that a same slot contains a mix of SBFD and non-SBFD symbols.

In some implementations, the SBFD layout in time may include a set of slot format configurations describing symbol locations within a slot where a particular configured subband partitioning is applied or a pattern determining slot locations where the set of lot format configurations apply.

In some implementations, a subband in a symbol may be configured to indicate that a transmission or reception is allowed to overlap the subband when scheduled dynamically or otherwise the transmission or reception is deprioritized.

In some implementations, apparatus 1210, as UE 110, may be configured with a set of slot configurations describing which symbol locations within a slot are partitioned and how scheduling is limited in each subband, and also indicating a specific subband partitioning in an event that more than one subband is configured.

In some implementations, the signaling may include a configuration of a symbol. Accordingly, responsive to a same subband partition being applied in all partitioned symbols, the configuration may indicate one category out of a set of categories.

In some implementations, the set of categories may include the following: (a) a non-partitioned symbol category; (b) a non-partitioned ad-hoc symbol category; (c) a partitioned between the DL and UL subbands category; (d) a partitioned between the DL subbands and ad-hoc subbands category; and (e) a partitioned between the UL subbands and the ad-hoc subbands category. Each of the ad-hoc subbands may be configured to indicate that a transmission or reception is allowed to overlap the respective ad-hoc subband when scheduled dynamically or otherwise the transmission or reception is deprioritized.

In some implementations, a TDD-UL-DL SFI signaling used for a UE link direction configuration may be replicated in configuring a first link direction over even-numbered subbands and a second link direction over odd-numbered subbands in one of the one or more frequency-domain subband partitions. In some implementations, a symbol may be not partitioned and may have a direction as indicated by either the first link direction or the second link direction responsive to either the first link direction or the second link direction matching for all subbands of the symbol.

FIG. 14 illustrates an example process 1400 in accordance with an implementation of the present disclosure. Process 1400 may represent an aspect of implementing various proposed designs, concepts, schemes, systems and methods described above, whether partially or entirely, including those pertaining to those described above. More specifically, process 1400 may represent an aspect of the proposed concepts and schemes pertaining to configuration of SBFD-aware UEs in mobile communications. Process 1400 may include one or more operations, actions, or functions as illustrated by one or more of blocks 1410 and 1420. Although illustrated as discrete blocks, various blocks of process 1400 may be divided into additional blocks, combined into fewer blocks, or eliminated, depending on the desired implementation. Moreover, the blocks/sub-blocks of process 1400 may be executed in the order shown in FIG. 14 or, alternatively, in a different order. Furthermore, one or more of the blocks/sub-blocks of process 1400 may be executed iteratively. Process 1400 may be implemented by or in apparatus 1210 and apparatus 1220 as well as any variations thereof. Solely for illustrative purposes and without limiting the scope, process 1400 is described below in the context of apparatus 1210 as a UE (e.g., UE 110) and apparatus 1220 as a network node or base station (e.g., terrestrial network node 125 or non-network node 128) of a network (e.g., network 130 as a 5G/NR mobile network). Process 1400 may begin at block 1410.

At 1410, process 1400 may involve processor 1212 of apparatus 1210 receiving, via transceiver 1216, a signaling from a network (e.g., network 130 via apparatus 1220). Process 1400 may proceed from 1410 to 1420.

At 1420, process 1400 may involve processor 1212 performing, via transceiver 1216, a measurement outside a DL subband while apparatus 1210, as UE 110, is not allowed to receive any signaling in the DL subband.

In some implementations, the signaling may configure a resource in one or more partitioned slots or symbols outside the DL subband. In such cases, in performing the measurement, process 1400 may involve processor 1212 performing a UE-UE CLI measurement in the configured resource.

In some implementations, in performing the measurement, process 1400 may involve processor 1212 performing a CSI-RS measurement.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of a user equipment (UE), a signaling from a network configuring one or more frequency-domain subband partitions per serving cell; and
communicating, by the processor, with the network using resources in the one or more frequency-domain subband partitions,
wherein each of the one or more frequency-domain subband partitions respectively comprises a set of uplink (UL) subbands and a set of downlink (DL) subbands, and
wherein each subband of the set of UL subbands and the set of DL subbands respectively comprises a set of one or more contiguous resource blocks (RBs).

2. The method of claim 1, wherein the signaling comprises a radio resource control (RRC) signaling that configures a UE-specific subband-fullduplex (SBFD) layout in time, in frequency, or in both time and frequency.

3. The method of claim 1, wherein the signaling further configures a subband-fullduplex (SBFD) layout in time under a serving cell.

4. The method of claim 3, wherein a pattern length of the SBFD layout in time matches that of a time-division duplex uplink and downlink (TDD-UL-DL) configuration.

5. The method of claim 4, wherein the TDD-UL-DL configuration comprises respective two patterns back-to-back and the SBFD layout also comprises respective two patterns of matching lengths back-to-back.

6. The method of claim 4, wherein one or more symbols belonging to a set of slots and symbols indicated as ‘flexible’ in the TDD-UL-DL configuration are indicated as partitioned by the SBFD layout in time configured to the UE.

7. The method of claim 4, wherein, responsive to a set of slots and symbols being indicated as ‘flexible’ in the TDD-UL-DL configuration by a slot-format indicator (SFI) signaling, one or more symbols belonging to the set of slots and symbols are non-partitioned irrespective the SBFD configuration.

8. The method of claim 3, wherein the SBFD layout in time comprises a common SBFD layout in time that is configured by a broadcast message as part of a system information block (SIB).

9. The method of claim 3, wherein the SBFD layout in time is configured at a resolution of symbols such that a same slot contains a mix of SBFD and non-SBFD symbols.

10. The method of claim 3, wherein the SBFD layout in time comprises a set of slot format configurations describing symbol locations within a slot where a particular configured subband partitioning is applied or a pattern determining slot locations where the set of lot format configurations apply.

11. The method of claim 1, wherein a subband in a symbol is configured to indicate that a transmission or reception is allowed to overlap the subband when scheduled dynamically or otherwise the transmission or reception is deprioritized.

12. The method of claim 1, wherein the UE is configured with a set of slot configurations describing which symbol locations within a slot are partitioned and how scheduling is limited in each subband, and also indicating a specific subband partitioning in an event that more than one subband is configured.

13. The method of claim 1, wherein the signaling comprises a configuration of a symbol, and wherein, responsive to a same subband partition being applied in all partitioned symbols, the configuration indicates one category out of a set of categories.

14. The method of claim 13, wherein the set of categories comprises:
a non-partitioned symbol category;
a non-partitioned ad-hoc symbol category;
a partitioned between the DL and UL subbands category;
a partitioned between the DL subbands and ad-hoc subbands category; and
a partitioned between the UL subbands and the ad-hoc subbands category,
wherein each of the ad-hoc subbands is configured to indicate that a transmission or reception is allowed to overlap the respective ad-hoc subband when scheduled dynamically or otherwise the transmission or reception is deprioritized.

15. The method of claim 1, wherein a time-division duplex uplink and downlink (TDD-UL-DL) slot-format indicator (SFI) signaling used for a UE link direction configuration is replicated in configuring a first link direction over even-numbered subbands and a second link direction over odd-numbered subbands in one of the one or more frequency-domain subband partitions.

16. The method of claim 15, wherein a symbol is not partitioned and has a direction as indicated by either the first link direction or the second link direction responsive to either the first link direction or the second link direction matching for all subbands of the symbol.

17. A method, comprising:
receiving, by a processor of a user equipment (UE), a signaling from a network; and
performing, by the processor, a measurement outside a downlink (DL) subband while the UE is not allowed to receive any signaling in the DL subband.

18. The method of claim 17, wherein the signaling configures a resource in one or more partitioned slots or symbols outside the DL subband, and wherein the performing of the measurement comprises performing a UE-to-UE cross link interference (UE-UE CLI) measurement in the configured resource.

19. The method of claim 17, wherein the performing of the measurement comprises performing a channel state information reference signal (CSI-RS) measurement.

20. An apparatus, comprising:
a transceiver configured to communicate wirelessly; and
a processor coupled to the transceiver and configured to perform operations comprising:
receiving, via the transceiver, a signaling from a network configuring one or more frequency-domain subband partitions per serving cell; and
communicating, via the transceiver, with the network using resources in the one or more frequency-domain subband partitions,
wherein each of the one or more frequency-domain subband partitions respectively comprises a set of uplink (UL) subbands and a set of downlink (DL) subbands, and
wherein each subband of the set of UL subbands and the set of DL subbands respectively comprises a set of one or more contiguous resource blocks (RBs).
